(19) United States
(12) Patent Application Publication
(10) Pub. No.: US 2011/0102520 A1
(43) Pub. Date: May 5, 2011

(54) Inkjet print head

(75) Inventors: Changsung Sean Kim, Yongin (KR); Won Chul Sim, Seongnam (KR); Jae Sang Lee, Seoul (KR); Hyun Ho Shin, Suwon (KR)

(73) Assignee: SAMSUNG ELECTRO-MECHANICS CO., LTD., Suwon (KR)

(21) Appl. No.: 12/654,670

(22) Filed: Dec. 29, 2009

(30) Foreign Application Priority Data
Oct. 29, 2009 (KR) 10-2009-0103711

(51) Int. Cl. B41J 2/175

(52) U.S. Cl. 347/85

(57) ABSTRACT

There is provided an inkjet print head. The inkjet print head includes a pressure chamber storing ink drawn from a reservoir in order to be ejected through a nozzle, a restrictor provided as a path between the reservoir and the pressure chamber, and a stepped part provided inside the pressure chamber and creating variations in ink flow inside the pressure chamber.

### CROSS-REFERENCE TO RELATED APPLICATIONS

This application claims the priority of Korean Patent Application No. 10-2009-0103711 filed on Oct. 29, 2009, in the Korean Intellectual Property Office, the disclosure of which is incorporated herein by reference.

### BACKGROUND OF THE INVENTION

1. Field of the Invention

The present invention relates to an inkjet print head, and more particularly, to an inkjet print head allowing for variations in the size and speed of ink droplets ejected therefrom even in the case that the inkjet print head is the same size as another inkjet print head by constructing a pressure chamber having a stepped structure in which pressure variations occur due to the driving force of a piezoelectric element.

2. Description of the Related Art

In general, an inkjet print head converts electrical signals into physical impulses so that ink droplets are ejected through a small nozzle.

An inkjet print head may be divided into two types according to actuator driving methods, a piezoelectric-type inkjet print head using a driving force caused by the transformation of piezoelectric materials and a bubble jet-type inkjet print head allowing ink to be ejected by bubbles generated in ink using heating elements.

In recent years, a piezoelectric inkjet head has been used in industrial inkjet printers. For example, it is used to directly form a circuit pattern by spraying ink prepared by melting metals such as gold or silver onto a printed circuit board (PCB). A piezoelectric inkjet head is also used for creating industrial graphics, or for the manufacturing of a liquid crystal display (LCD), an organic light emitting diode (OLED), and a solar cell.

Inside an inkjet print head of an industrial inkjet printer, there are provided an inlet through which ink is drawn from a cartridge, a reservoir storing the ink being drawn, and a pressure chamber transferring the driving force of an actuator so as to move the ink stored in the reservoir toward a nozzle.

With the recent expansion of industrial inkjet printer applications, the size and speed of ink droplets have been needed to be controlled, and thus further research has been required.

A pressure chamber according to the related art has the same height at a portion connected with a restrictor and at a portion connected with a nozzle. That is, the pressure chamber has a regular parallelepiped structure in which the upper and lower surfaces thereof have a uniform distance therebetween.

By causing the distance between the upper and lower surfaces of a pressure chamber to be uniform, if inkjet print heads have the same size, ink droplets of consistent size and speed are the result. Therefore, there is a need for the development of an inkjet print head having a difference in the size and speed of ink droplets to match desired inkjet applications, even in the case that the inkjet print head is the same size as another inkjet print head.

### SUMMARY OF THE INVENTION

An aspect of the present invention provides an inkjet print head allowing for variations in the size and speed of ink droplets ejected therefrom even in the case that the inkjet print head is the same size as another inkjet print head by constructing a pressure chamber having a stepped structure in which pressure variations occur due to the driving force of a piezoelectric element.

According to an aspect of the present invention, there is provided an inkjet print head including: a pressure chamber storing ink drawn from a reservoir in order to be ejected through a nozzle; a restrictor provided as a path between the reservoir and the pressure chamber; and a stepped part provided inside the pressure chamber and creating variations in ink flow inside the pressure chamber.

The stepped part may have a stepped upper surface having increased height in a direction toward the restrictor inside the pressure chamber.

The stepped part may have a multiple stepped structure and allow for gradually increased height in the direction toward the restrictor.

The stepped part may have a stepped upper surface having increased height in a direction toward the nozzle inside the pressure chamber.

The stepped part may have a multiple stepped structure and allow for gradually increased height in the direction toward the nozzle.

The stepped part may have a stepped upper surface having increased height in a direction toward both the restrictor and the nozzle inside the pressure chamber.

The stepped part may have a multiple stepped structure and allow for gradually increased height in the direction toward both the restrictor and the nozzle.

The stepped part may have a stepped upper surface having reduced height in a direction toward both the restrictor and the nozzle inside the pressure chamber.

The stepped part may have a multiple stepped structure and allow for gradually reduced height in the direction toward both the restrictor and the nozzle.

The stepped part may have a micro-pillar provided thereon.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is an exploded perspective view schematically illustrating an inkjet print head according to an exemplary embodiment of the present invention;

FIG. 2 is a cross-sectional view illustrating an inkjet print head according to an exemplary embodiment of the present invention;

FIG. 3 is a cross-sectional view illustrating an inkjet print head according to another exemplary embodiment of the present invention;

FIG. 4 is a cross-sectional view illustrating an inkjet print head according to another exemplary embodiment of the present invention;

FIG. 5 is a cross-sectional view illustrating an inkjet print head according to another exemplary embodiment of the present invention;

FIG. 6 is a cross-sectional view illustrating an inkjet print head according to another exemplary embodiment of the present invention;

FIG. 7 is a cross-sectional view illustrating an inkjet print head according to another exemplary embodiment of the present invention; and

FIG. 8 is a schematic perspective view illustrating micro-pillars arranged in an inkjet print head according to an exemplary embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

Throughout the drawings, the same reference numerals will be used to refer to the same or like parts.

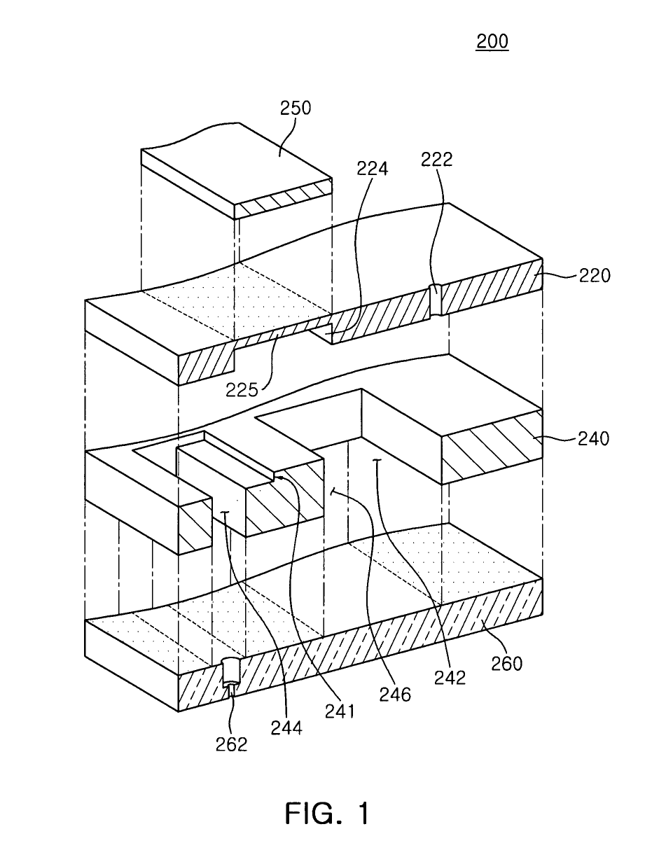

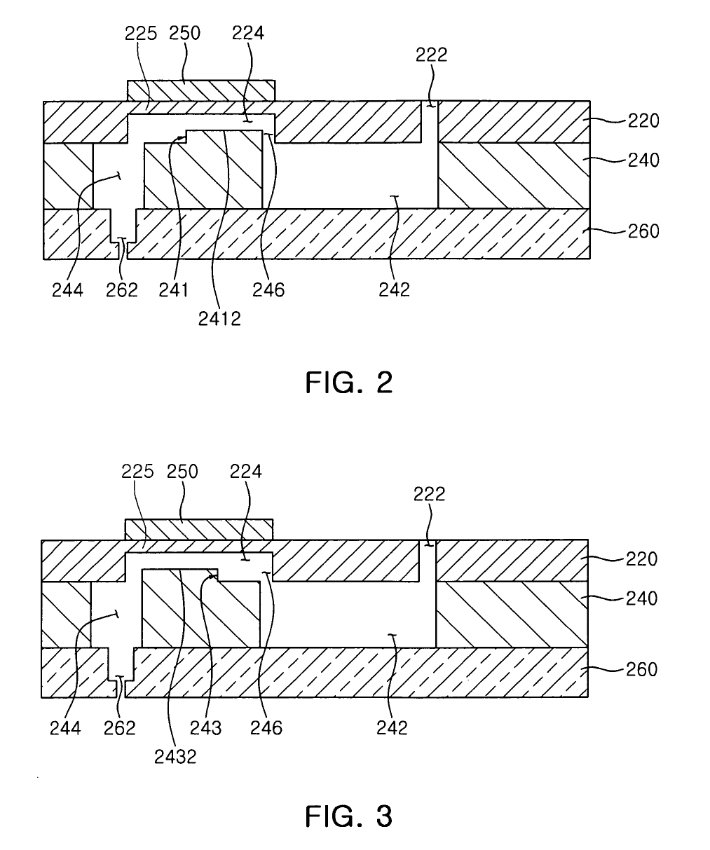

FIG. 1 is an exploded perspective view schematically illustrating an inkjet print head according to an exemplary embodiment of the present invention. FIG. 2 is a cross-sectional view illustrating an inkjet print head according to an exemplary embodiment of the present invention.

Referring to FIGS. 1 and 2, an inkjet print head 200 according to an exemplary embodiment of the invention may include a pressure chamber 224, a restrictor 246, and a stepped part 241.

The inkjet print head 200 is a structure manufactured by stacking silicon or glass substrate plates. Holes or grooves are formed in the substrate plates by micro electro mechanical systems (MEMS) processing and those substrate plates are stacked, and thus the pressure chamber 224, the restrictor 246, and the stepped part 241 are formed.

The inkjet print head 200 according to this embodiment may be formed by stacking lower, intermediate, and upper substrates 260, 240 and 220.

A silicon plate of the inkjet print head 200 may have a double layer structure. Also, more substrates may be stacked to form an inkjet print head.

The upper substrate 220 may have an inlet 222 and the pressure chamber 224 formed therein. The inlet 222 allows ink to be drawn into the inkjet print head 200, and the pressure chamber 224 allows ink to be supplied with a driving force for ejection. On the top of the pressure chamber 224, a piezoelectric element 250 may be provided to have a membrane 225 disposed therebetween. The piezoelectric element 250 supplies the pressure chamber 224 with the driving force for ink ejection.

The piezoelectric element 250 may allow ink ejection to be made by transforming the membrane 225 that is the upper surface of the pressure chamber 224. A piezoelectric element may convert electrical energy into mechanical energy or vice versa, and its representative material is Pb (Zr, Ti) O₃. Also, for the ink ejection, a bubble jet or thermal jet method, besides a piezoelectric method using the piezoelectric element 250, may be used.

The lower substrate 260 may have a nozzle 262 formed therein. The intermediate substrate 240 may have a damper 244 and a reservoir 242 formed therein. The reservoir 242 stores ink inside the inkjet print head 200. Also, the intermediate substrate 240 may have the restrictor 246 formed therein in order to prevent the ink of the pressure chamber 224 from flowing backward into the reservoir 242.

The piezoelectric element 250 may be formed to have electrodes on the top and bottom of a piezoelectric material layer that is transformed by current supply. Those upper and lower electrodes may be connected with a flexible printed circuit board in order to apply voltage thereto.

The nozzle 262 may eject the ink stored in the pressure chamber 224 in the form of droplets by the driving force of the piezoelectric element 250. Here, the nozzle 262 decides the size and direction of the droplets.

The intermediate substrate 240 may have the stepped part 241 formed therein. The stepped part 241 may allow the upper and lower surfaces of the pressure chamber 224, which are formed by bonding the intermediate and upper substrates 240 and 220, to have different depths therebetween.

Referring to FIG. 2, the stepped part 241 has a stepped upper surface 2412 formed to have increased height in a direction toward the restrictor 246. That is, the depth of the pressure chamber 224 increases in a direction toward the nozzle 262. Such a structure is defined as a diffusion-type pressure chamber.

As a result of a simulation of the volume and ejection speed of ink droplets from an inkjet print head including such a diffusion-type pressure chamber, the volume of ink droplets was 0.92 pL and the ejection speed was 1.59 m/s.

In a simulation of the volume and ejection speed of ink droplets from an inkjet print head including a conventional flat-type pressure chamber and having the same size as the inkjet print head including the diffusion-type pressure chamber, the volume of ink droplets was 1.28 pL and the ejection speed was 2.78 m/s.

That is, the inkjet print head including the diffusion-type pressure chamber reduces the volume and ejection speed of ink droplets.

The stepped part 241 inside the diffusion-type pressure chamber allows the depth of the pressure chamber 224 to be increased before ink is drawn into the nozzle 262, thereby acting as a kind of damper.

FIG. 3 is a cross-sectional view of an inkjet print head according to another exemplary embodiment of the present invention.

Referring to FIG. 3, in an inkjet print head according to this embodiment, in contrast to the inkjet print head according to the aforementioned embodiment, a stepped part 243 has a stepped upper surface 2432 formed to have increased height in a direction toward the nozzle 262. That is, the depth of the pressure chamber 224 decreases in a direction toward the nozzle 262. Such a structure is defined as a convergence-type pressure chamber.

As a result of a simulation of the volume and ejection speed of ink droplets from an inkjet print head including such a convergence-type pressure chamber, the volume of ink droplets was 1.13 pL and the ejection speed was 2.20 m/s.

In a simulation of the volume and ejection speed of ink droplets from an inkjet print head including a conventional flat-type pressure chamber and having the same size as the inkjet print head including the convergence-type pressure chamber, the volume of ink droplets was 1.28 pL and the ejection speed was 2.78 m/s.

That is, the inkjet print head including the convergence-type pressure chamber reduces the volume and ejection speed of ink droplets.

The convergence-type pressure chamber allows ink to flow smoothly toward a nozzle outlet direction and prevents ink from flowing backward into the restrictor 246 after being ejected therefrom.

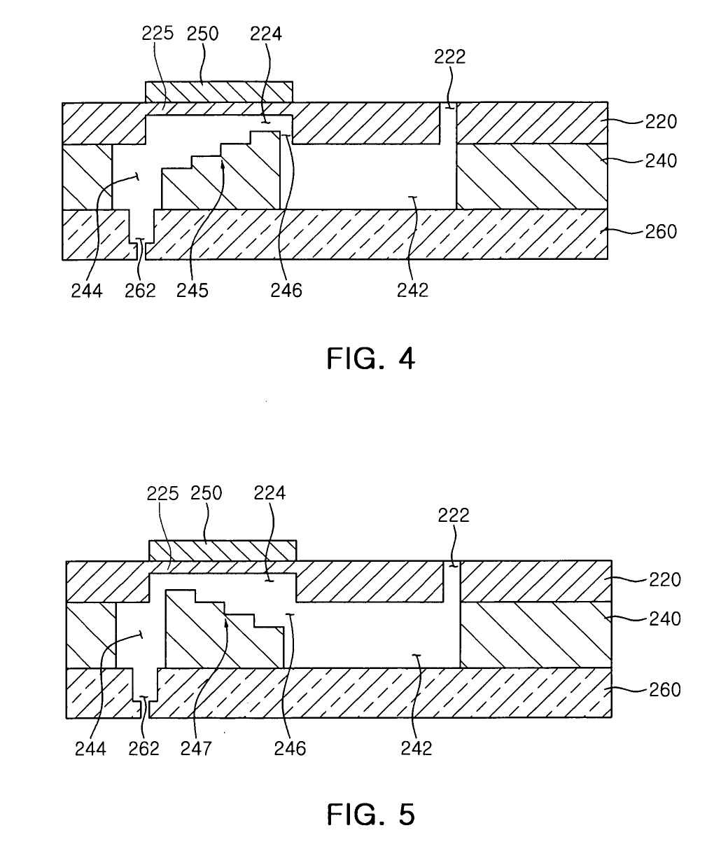

FIG. 4 is a cross-sectional view of an inkjet print head according to another exemplary embodiment of the present invention. FIG. 5 is a cross-sectional view of an inkjet print head according to another exemplary embodiment of the present invention.

Referring to FIG. 4, a stepped part 245 has a multiple stepped structure gradually increasing the height of the stepped part 245 in a direction toward the restrictor 246 and gradually increasing the depth of the pressure chamber 224 in a direction toward the nozzle 262, thereby forming a diffusion-type pressure chamber.

Also, referring to FIG. 5, a stepped part 247 has a multiple stepped structure gradually increasing the height of the stepped part 247 in a direction toward the nozzle 262 and gradually reducing the depth of the pressure chamber 224 in a direction toward the nozzle 262, thereby forming a convergence-type pressure chamber.

As shown in FIGS. 4 and 5, the diffusion-type and convergence-type pressure chambers having a multiple stepped structure may allow the flowing of ink to be smoothly adjusted, and also allow the volume and ejection speed of ink droplets to be adjusted.

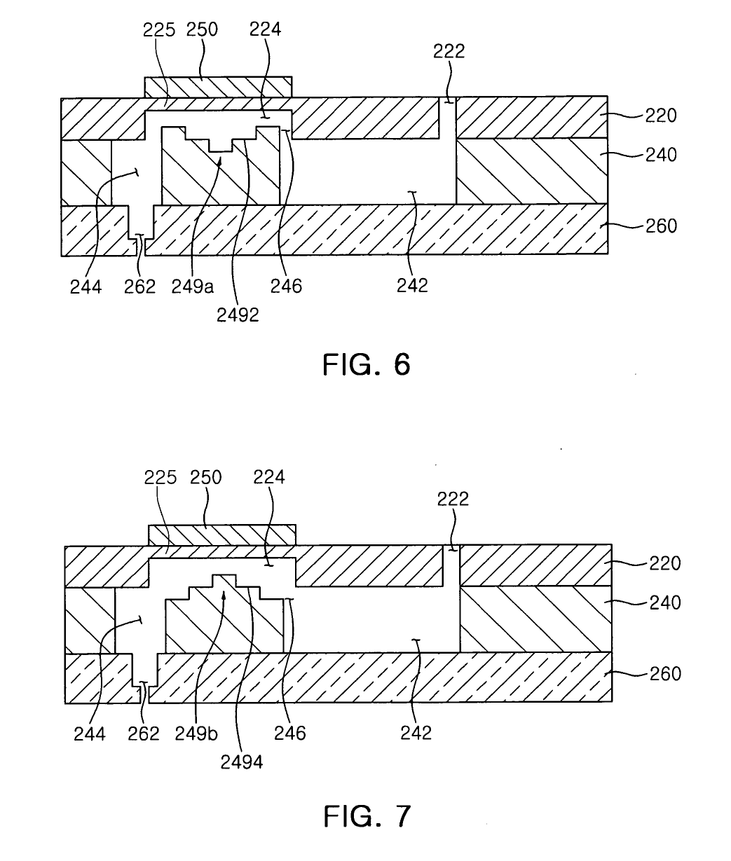

FIG. 6 is a cross-sectional view of an inkjet print head according to another exemplary embodiment of the present invention. FIG. 7 is a cross-sectional view of an inkjet print head according to another exemplary embodiment of the present invention.

Referring to FIG. 6, a stepped part 249a may have stepped upper surfaces 2492 formed to have increased height in a direction toward both the restrictor 246 and the nozzle 262 inside the pressure chamber 224.

Also, the stepped part 249a has a multiple stepped structure and allows the height of the stepped part 249a to be gradually increased in a direction toward both the restrictor 246 and the nozzle 262, whereby an inkjet print head has a structure in which the depth of the pressure chamber 224 gradually decreases in a direction toward both the restrictor 246 and the nozzle 262.

Referring to FIG. 7, a stepped part 249b may have stepped upper surfaces 2494 formed to have reduced height in a direction toward both the restrictor 246 and the nozzle 262 inside the pressure chamber 224.

Also, the stepped part 249b has a multiple stepped structure and allows the height of the stepped part 249b to be gradually reduced in a direction toward both the restrictor 246 and the nozzle 262, whereby an inkjet print head has a structure in which the depth of the pressure chamber 224 gradually increases in a direction toward both the restrictor 246 and the nozzle 262.

By properly combining the principles of the diffusion-type and convergence-type pressure chambers, the volume, speed and flow rate of ink droplets may be improved.

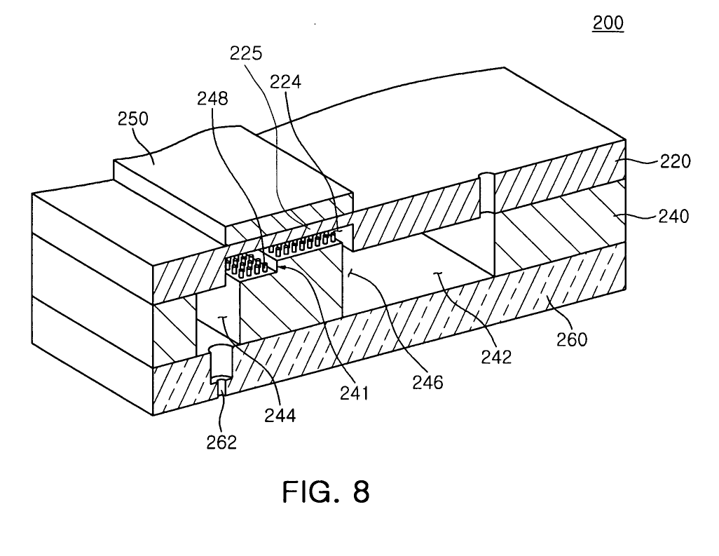

FIG. 8 is a schematic perspective view illustrating micro-pillars arranged in an inkjet print head according to an exemplary embodiment of the present invention.

Referring to FIG. 8, micro-pillars 248 may be formed on a stepped part 241 inside the pressure chamber 224.

The micro-pillars 248 attenuate sound waves generated in the pressure chamber 224 by the driving force of the piezoelectric element 250 and generate flow resistance to ink flowing backward into the restrictor 246 after ink is ejected from the pressure chamber 224.

That is, the micro-pillars 248 may supplement the flow resistance to ink of the convergence-type pressure chamber flowing backwards and complement the flow resistance to ink of the diffusion-type pressure chamber flowing backwards.

The inkjet print head according to exemplary embodiments of the present invention has an effect to enable variations in the size and speed of ink droplets by allowing for variations in the distance between the upper and lower surfaces of a pressure chamber even in the case that the inkjet print head is the same size as another inkjet print head.

Also, an inkjet print head having desired size and speed of ink droplets in inkjet applications may be selected by allowing the size and speed of ink droplets to be different.

As set forth above, according to exemplary embodiments of the invention, an inkjet print head achieves variations in the size and speed of ink droplets by constructing a pressure chamber in a manner that the distances between the upper and lower surfaces of the pressure chamber differ even in the case that the inkjet print head has the same size as another inkjet print head.

Also, the variations in the size and speed of ink droplets may allow for selections of an inkjet print head having desired size and speed of ink droplets in inkjet applications.

While the present invention has been shown and described in connection with the exemplary embodiments, it will be apparent to those skilled in the art that modifications and variations can be made without departing from the spirit and scope of the invention as defined by the appended claims.

What is claimed is:

1. An inkjet print head comprising:
a pressure chamber storing ink drawn from a reservoir in order to be ejected through a nozzle;
a restrictor provided as a path between the reservoir and the pressure chamber; and
a stepped part provided inside the pressure chamber and creating variations in ink flow inside the pressure chamber.

2. The inkjet print head of claim 1, wherein the stepped part has a stepped upper surface having increased height in a direction toward the restrictor inside the pressure chamber.

3. The inkjet print head of claim 2, wherein the stepped part has a multiple stepped structure and allows for gradually increased height in the direction toward the restrictor.

4. The inkjet print head of claim 1, wherein the stepped part has a stepped upper surface having increased height in a direction toward the nozzle inside the pressure chamber.

5. The inkjet print head of claim 4, wherein the stepped part has a multiple stepped structure and allows for gradually increased height in the direction toward the nozzle.

6. The inkjet print head of claim 1, wherein the stepped part has a stepped upper surface having increased height in a direction toward both the restrictor and the nozzle inside the pressure chamber.

7. The inkjet print head of claim 6, wherein the stepped part has a multiple stepped structure and allows for gradually increased height in the direction toward both the restrictor and the nozzle.

8. The inkjet print head of claim 1, wherein the stepped part has a stepped upper surface having reduced height in a direction toward both the restrictor and the nozzle inside the pressure chamber.

9. The inkjet print head of claim 8, wherein the stepped part has a multiple stepped structure and allows for gradually reduced height in the direction toward both the restrictor and the nozzle.

10. The inkjet print head of claim 1, wherein the stepped part has a micro-pillar provided thereon.
